(19) United States
(12) Patent Application Publication
(10) Pub. No.: US 2024/0084583 A1
(43) Pub. Date: Mar. 14, 2024

(54) MASONRY CAVITY WALL TIE

(71) Applicant: Terremoto Limited, Auckland (NZ)

(72) Inventor: Dmytro DIZHUR, Auckland (NZ)

(21) Appl. No.: 18/469,405

(22) Filed: Sep. 18, 2023

Related U.S. Application Data
(63) Continuation-in-part of application No. 16/714,256, filed on Dec. 13, 2019, now abandoned.

(51) Int. Cl. E04B 1/41; F16B 5/02

(52) U.S. Cl. CPC E04B 1/4178; F16B 5/0275

(57) ABSTRACT

A masonry cavity wall tie comprises a shank having a tip at one end, a head at a second distal end, ductility measured as a bending angle under complete three repeated cycles without rupture of between about 12.5° and 26°, a shank diameter between about 5.5 mm and about 10 mm, and first, second, and third shank portions extending at least partially towards the head. The first shank portion commences at the tip and has a helical thread of a diameter along a predetermined longitudinal length of the first shank portion. The second shank portion commences at an end of the first shank portion, is unthreaded, and is between about 25% and about 30% of the wall tie length. The third shank portion commences at an end of the second shank portion and has a helical thread of the diameter along a predetermined longitudinal length of the second shank portion.

### CROSS-REFERENCE TO RELATED APPLICATIONS

The present application is a continuation in part and claims priority to U.S. application Ser. No. 16/714,256 filed with the United States Patent and Trademark Office on Dec. 13, 2019, and entitled “MASONRY HARDWARE,” which is incorporated herein by reference in its entirety for all purposes.

### FIELD

This invention relates to masonry cavity wall ties in particular masonry cavity wall ties suitable for use with clay brick or soft stone block.

### BACKGROUND

Loadbearing cavity (aka hollow) wall construction is a form of masonry wall construction where two leaves of unreinforced clay brick masonry or soft stone block masonry (URM) are separated by a continuous air cavity. In recent times the two leaves are interconnected using some form of tie system. In earlier times a tie system was not used. Observations of building damaged in earthquakes and strong winds indicated that failure of URM construction, typically cavity walls, was critical in terms of structural stability and safety issues, and collapse of the outer masonry cavity wall layer due to wall bending failure was commonly encountered. Also observed was the poor quality of masonry construction, mortar strength and cavity wall ties that often corroded, resulting in a poor connection between the two masonry wall layers. Therefore, the capacity of wall ties to transfer lateral load was significantly diminished due to cross-sectional reduction.

In a similar manner inadequate or missing shear and tension connections between the unreinforced masonry (URM) bearing wall and the floor or roof can cause issues. The most significant deficiency in URM bearing wall buildings is the lack of an adequate positive (i.e. mechanical) tie between the masonry walls and the floor and roof diaphragms. Ties are usually separated into two categories: tension ties and shear ties. Tension ties transfer out-of-plane inertial loads perpendicular to the face of the masonry back into the structural elements. Shear ties transfer loads from the structural elements into the wall where they are resisted by in-plane action of the wall. Tension ties help keep the walls from falling away from the diaphragms; shear ties help keep the diaphragm from sliding along parallel to the wall.

All references cited herein are incorporated by reference to the maximum extent allowable by law.

### SUMMARY

According to one example embodiment there is provided a masonry cavity wall tie, comprising:
a shank having a first shank portion, a second shank portion, and a third shank portion, the shank having a tip at one end and a head at a second distal end, the shank having ductility measured as a bending angle under complete three repeated cycles without rupture of between about 12.5° and 26°;
the first shank portion commencing at the tip of the shank at a first shank portion first end and extending partially towards the head of the shank and ending at a first shank portion second end;
the second shank portion commencing at the first shank portion second end at a second shank portion first end and extending towards the head of the shank and ending at a second shank portion second end;
the third shank portion commencing at the second shank portion second end at a third shank portion first end and extending towards the head of the shank and ending at a third shank portion second end;
the first shank portion having a helical thread of a first diameter along a predetermined longitudinal length of the first shank portion; and
the second shank portion being unthreaded; and
the third shank portion having a helical thread of a second diameter along a predetermined longitudinal length of the second shank portion,
wherein the first and second diameters are the same, wherein the second shank portion is between about 25% and about 30% of the wall tie length and wherein the shank diameter is between about 5.5 mm and about 10 mm.

Preferably the masonry tie is adapted for use with clay brick or soft stone masonry.

Preferably the clay bricks or stone blocks have up-to 35 MPa compression strength.

Preferably the bending angle is about 25.7°.

Preferably the masonry tie is adapted for use with a multi-leaf (wythe) masonry wall structure.

Preferably the tapered helical screw portions have a thread spacing of between about 5.5 mm and about 10 mm.

Preferably the thread spacing is about 6 mm.

Preferably the shank diameter is about 6 mm.

Preferably the second unthreaded portion is between about 25% and about 30% of the wall tie length.

Preferably the second unthreaded portion is about 28% of the wall tie length.

Preferably the second unthreaded portion length is between about 60 mm and about 90 mm.

According to a further example embodiment there is provided a masonry fastener, comprising:
a shank having a first and second portions, a tip at one end and a head at a second distal end, the shank having ductility measured as a bending angle under complete three repeated cycles without rupture of between about 10.0° and 22.0°;
the first portion having a tapered helical screw portion along a predetermined longitudinal length thereof, the tapered helical screw portion commencing at a tip and extending partially towards the head; and
the second portion having a tapered helical screw portion along a predetermined longitudinal length thereof, the tapered helical screw portion commencing at the first portion and ending at the head.

Preferably the masonry is clay brick or soft stone masonry.

Preferably the clay bricks or stone blocks have up-to 35 MPa compression strength.

Preferably the bending angle is about 21.0°.

Preferably the tapered helical screw portions have a thread spacing of between about 6 mm and about 10 mm.

Preferably the thread spacing is about 8 mm.

Preferably the shank has a diameter between about 6 mm and about 10 mm.

Preferably the shank diameter is about 8 mm.

Preferably the shank has a length between about 160 mm and about 340 mm.

It is acknowledged that the terms “comprise”, “comprises” and “comprising” may, under varying jurisdictions, be attributed with either an exclusive or an inclusive meaning. For the purpose of this specification, and unless otherwise noted, these terms are intended to have an inclusive meaning—i.e., they will be taken to mean an inclusion of the listed components which the use directly references, and possibly also of other non-specified components or elements.

Reference to any document in this specification does not constitute an admission that it is prior art, validly combinable with other documents or that it forms part of the common general knowledge.

### BRIEF DESCRIPTION OF THE DRAWINGS

The accompanying drawings which are incorporated in and constitute part of the specification, illustrate embodiments of the invention and, together with the general description of the invention given above, and the detailed description of embodiments given below, serve to explain the principles of the invention, in which:

FIG. 1 is a diagram of an embodiment of a wall tie connecting two masonry walls made of clay bricks or soft stone blocks;

FIG. 2 is an isometric view of the wall tie shown in FIG. 1;

FIG. 3 is a side view of the wall tie shown in FIG. 1;

FIG. 4 is a side view of the wall tie shown in FIG. 1 with the proportions shown;

FIG. 5 is a close-up view of the threads of the wall tie shown in FIG. 1;

FIG. 6 is a top view of the wall tie shown in FIG. 1;

FIG. 7 is a bottom view of the wall tie shown in FIG. 1;

FIG. 8 is a cross section of the head of the wall tie shown in FIG. 1;

FIG. 9 is a diagram of an embodiment of a fastener connecting a wooden support to masonry including clay bricks and soft stone blocks;

FIG. 10 is an isometric view of the fastener shown in FIG. 9;

FIG. 11 is a side view of the fastener shown in FIG. 9;

FIG. 12 is a cross sectional side view of the fastener shown in FIG. 9;

FIG. 13 is a top view of the fastener shown in FIG. 9;

FIG. 14 is a bottom view of the fastener shown in FIG. 9;

FIG. 15 is an isometric view of the fastener shown in FIG. 10 in a further embodiment;

FIG. 16 is a side view of the fastener shown in FIG. 15;

FIG. 17 is a cross sectional side view of the fastener shown in FIG. 15;

FIG. 18 is a top view of the fastener shown in FIG. 15; and

FIG. 19 is a bottom view of the fastener shown in FIG. 15.

### DETAILED DESCRIPTION

It may be desirable to create minimally intrusive and reversible strengthening (earthquake and/or wind loading retrofit) options for unreinforced masonry buildings with cavity type walls. The wall may be made of clay bricks or soft stone blocks. The clay brick may be fired clay bricks.

Further it may be desirable to create a composite interconnection action between separate wall layers in unreinforced masonry buildings with cavity type walls.

The material strength of clay bricks or soft stone blocks/units can be vastly variable. The soft stone block material includes but is not limited to sandstone, limestone, tuff, or similar. The wall ties and fasteners discussed herein are applicable for use with stone blocks having up-to 35 MPa compression strength. Similar compression strength applies to fired clay brick.

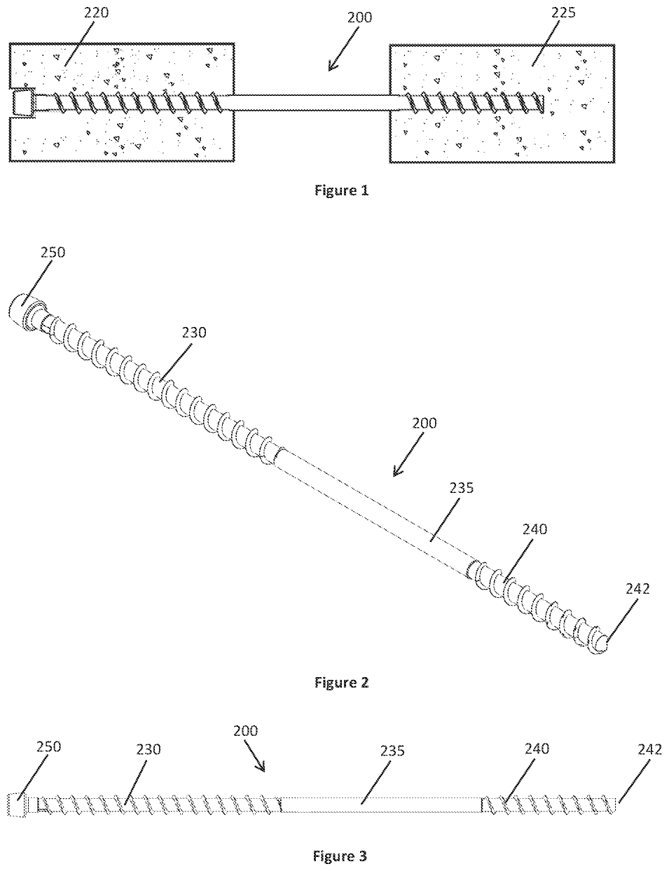

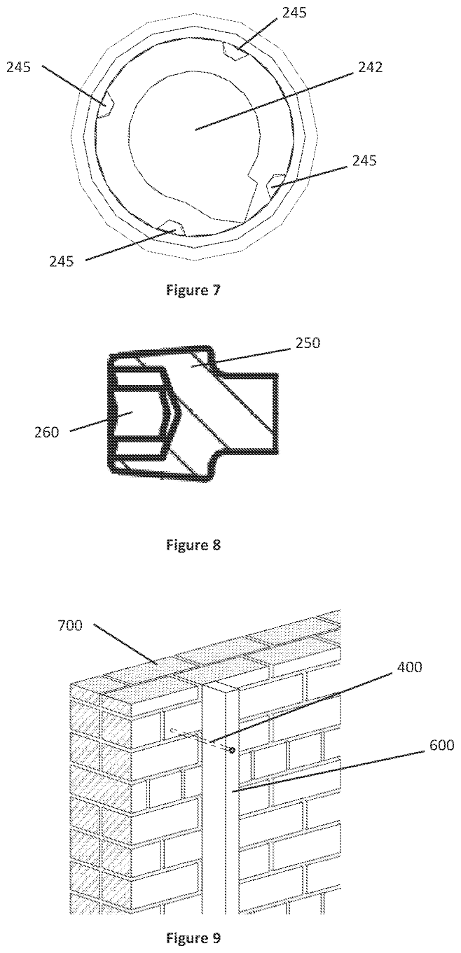

FIGS. 1 to 8 illustrate a clay brick or soft stone block wall tie 200 according to an example embodiment.

The clay brick or soft stone block wall tie 200 connects unreinforced clay bricks or soft stone blocks 220, 225.

The clay brick or soft stone block wall tie 200 includes a shank having a first threaded portion 240 extending from the tip 242 of the clay brick or soft stone block wall tie 200 partially along the shank.

A third portion 230 is also threaded.

A second unthreaded portion 235 extends between the first threaded portion 240 and the third threaded portion 230. The diameter of the unthreaded portion 235 is in one embodiment of a greater diameter than the center core diameter of the first and third threaded portions 230, 240.

The threads of the first portion 230 and third portion 240 are preferably sharp crested helical threads formed along the clay brick or soft stone block wall tie 200 shank.

Notches 245 may be formed on the crest of the helical thread along the length of the screw, more frequent end notches (saw teeth) may be formed in about the first three revolutions at the tip 242 in order to facilitate embedment of the crest into the masonry substrate.

The notches 245 may facilitate embedment of the crest of the helical threads into the masonry substrate of the clay bricks or soft stone blocks.

The clay brick or soft stone block wall tie 200 forms an anchor device which is designed to be secured within a bore formed in a multi-leaf (wythe) masonry wall structure.

The clay brick or soft stone block wall tie 200 fastens itself into multi-leaf (wythe) masonry when it is screwed and will not be loosen from vibrations or use (such as earthquake or wind induced).

The thread 244 of the clay brick or soft stone block wall tie 200 is designed to cut a spiral groove into the masonry substrate when inserted into a predrilled hole and turned. The spiral groove cuts without damaging the surrounding clay brick or soft stone blocks.

The clay brick or soft stone block wall tie 200 is turned by a head 250 on the clay brick or soft stone block wall tie 200. The head 250 has in one embodiment a torx head 260, however other suitable head types including hex, square recess, pozi, p Phillips, slotted and hex head cap screw may be used.

The clay brick or soft stone block wall tie 200 may be suitable as a replacement of original wall ties and may provide high tensile capacity for earthquake and wind resistance of cavity and veneer type masonry construction.

Further the clay brick or soft stone block wall tie 200 may provide a high level of interleaf shear transfer for enhanced earthquake and wind resistance and may be used to secure multiple layers of masonry for a resilient interconnected masonry wall cross-section.

The clay brick or soft stone block wall tie 200 may be used without resin or grout and there is no mechanical expansion. The clay brick or soft stone block wall tie 200 provides a quick, easy, non-disruptive installation.

In one embodiment the clay brick or soft stone block wall tie 200 may be recessed below face of masonry as seen in FIG. 1.

The clay brick or soft stone block wall tie 200 threaded portions 230, 240 will typically have a thread spacing of between about 5.5 mm and about 10 mm. Preferably the thread spacing is about 6 mm.

The clay brick or soft stone block wall tie 200 shank diameter is between about 5.5 mm and about 10 mm. Preferably the shank diameter is about 6 mm.

The clay brick or soft stone block wall tie 200 shank length is between about 200 mm and about 340 mm depending on the size of the clay brick or soft stone block and the space between the clay bricks or soft stone block. In one embodiment the length is 240 mm.

While illustrated and described in reference to double brick or block cavities, the clay brick or soft stone block wall tie 200 could be used in a triple brick or block situation. In this situation the first or third threaded portions would be lengthened to suit depending on whether or not the double brick or block layer of a triple brick or block cavity was being passed through or screwed into.

The clay brick or soft stone block wall tie 200 is preferably manufactured using tempered steel to provide ductile response. Other materials (manganese, carbon, silicon, aluminum, phosphorus) may be used that provide a good ductile response.

EN 14592 provides a ductility measure with the level of performance measured from S1 to S3. S3 being the highest level. The test requires a fitting being bent three times to a bending angle.

The degrees of bendability using this measure is expressed as:

$$a = \frac{45}{{d}^{0.7}}$$

α is expressed in degrees and d is the nominal diameter of the shank, in mm.

Ductility class S3 requires three repeated cycles at the bending angle before breaking of S3=2×α

In a typical embodiment

$$a = \frac{45}{{d}^{0.7}} = \frac{45}{{6}^{0.7}} = 12.84 and$$

$$S 3 = 2 \times a = 12.84 \times 2 = 25.7$$

Thus, the clay brick or soft stone block wall tie 200 would typically have a bending angle of about 25.7°. In a preferred embodiment the bending angle under complete three repeated cycles without rupture would be between about 12.5° and 26°.

The clay brick or soft stone block wall tie 200 may be installed using the following installation procedure:
Mark the position for the masonry cavity screw on the face of the near brick/block leaf.
Drill a suitable diameter pilot hole through the near leaf and into the back-up substrate, to predetermined depth, using a rotary percussion drill. Using the preferred diameter clay brick or soft stone block wall tie 200 the hole would be 6 mm.
Drill a hole for the countersinking of the head 250.
Insert the clay brick or soft stone block wall tie 200 into pre-drilled hole.
Manually or power-drive the clay brick or soft stone block wall tie 200 into position until its outer end is recessed below the face of the near leaf.
Make good the entry hole with matching materials (if needed).

The masonry wall tie 200 has been developed to enable composite out-of-plane (OoP) behavior in unreinforced masonry (URM) cavity walls under lateral loading conditions. Historically, masonry ties, both in original construction and remedial post-installed masonry ties have been flexible (“flexible” defined as not being able to transfer shear through the ties shank across a cavity). The purpose of this is to allow them to withstand the imposed deformation differences between outer and inner leafs 220, 225 of the cavity wall due to shrinkage and temperature differences during their lifetime, without any breakage occurring.

Flexible masonry ties are unable to transfer shear loads across the cavity of a cavity wall. As a result, each leaf 220, 225 of the cavity wall, under lateral loading, rocks about the width of the individual leaf.

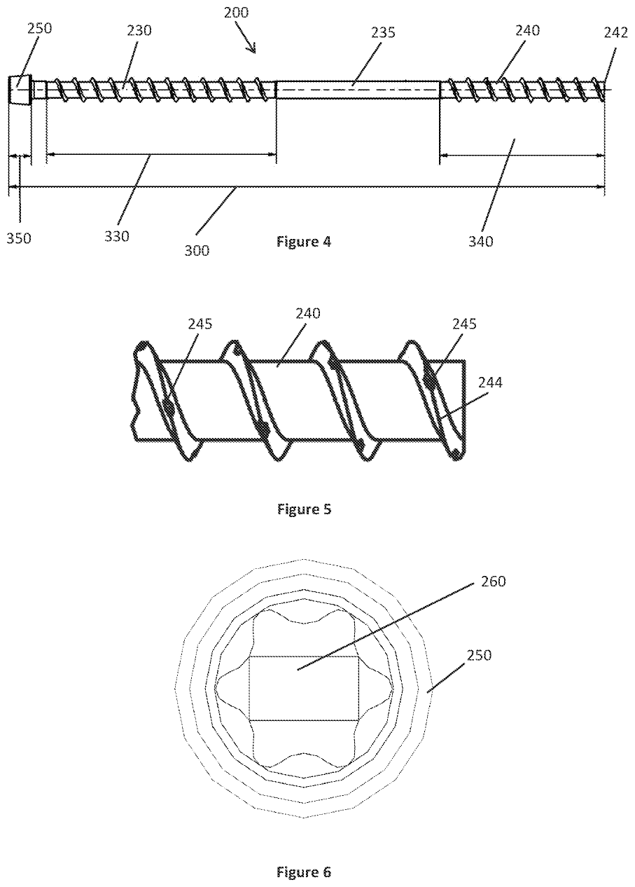

The masonry wall tie 200, is not flexible (defined as being able to transfer shear through its shank across a cavity). However, it has been designed to match the initial displacement profile of flexible ties, refer FIGS. 4, 5, and 7 (Tocher H., Slavin N., Maduh U., Dizhur D. (2020). Retrofitted URM cavity walls experimentally validated and a simplified out-of-plane assessment. In Structural Engineering Society Journal (2020), 33(2)), when installed in URM cavity walls to accommodate thermal and shrinkage effects. The initial displacement that enables this occurs between the threads and the URM material.

Because of these two properties this masonry wall tie 200 is referred to as “semi-rigid” (Tocher 2020) and will be referred to as this herein.

A semi-rigid tie 200 can be used to enable composite OoP behavior in URM cavity walls under lateral loading (Tocher et al. 2020). The mechanism that enables this is the transfer of shear loads between the two leaf's 220, 225 of a cavity wall.

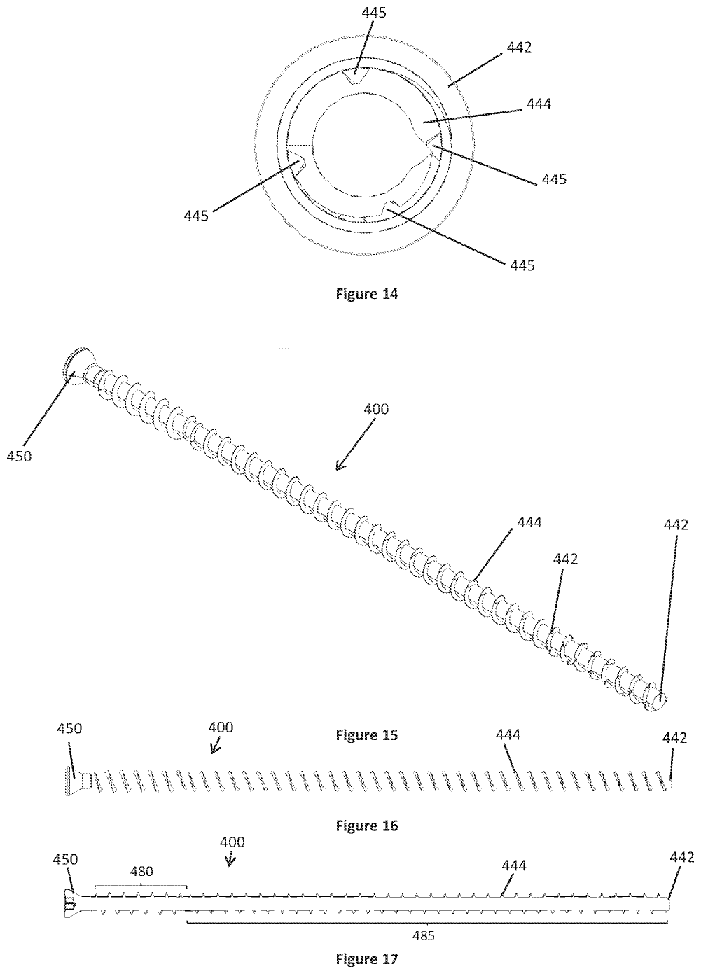

When a URM wall is enabled to act OoP as a composite section, it will rock about the width of the full wall cross section under lateral loading, refer FIG. 13 (Tocher et al. 2020). Enabling composite OoP behavior in URM cavity walls can increase the lateral strength of these walls by up to 500% and increase their OoP displacement capacity by up to 200%, refer FIG. 5 (Tocher et al. 2020). This is particularly useful when seismically retrofitting this type of historical construction.

The non-threaded central portion of the shank, 235, has been designed to increase the cross-sectional area and second moment of area of the masonry tie 200 shank portion that crosses the cavity of a URM cavity wall. This increases the shear and bending capacity of the masonry tie 200 in the section critical to enabling OoP composite behavior. As a result, less ties 200 with this feature are required to enable composite out-of-plane behavior in URM cavity walls.

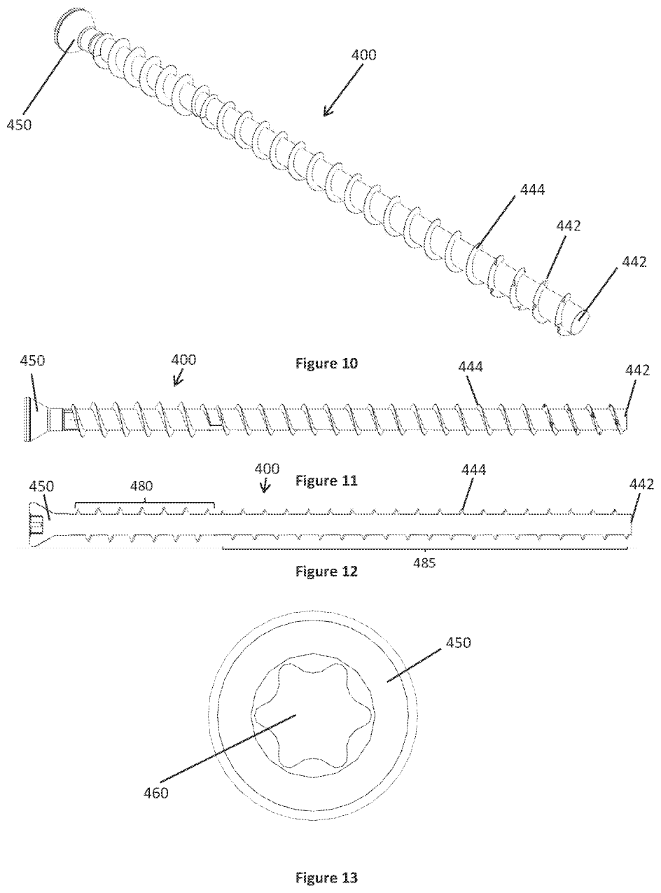

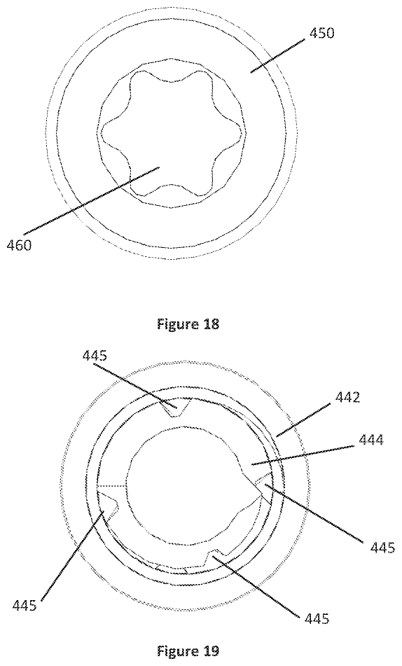

In a further embodiment a clay brick or soft stone block fastener 400 illustrated in FIGS. 9 to 19 may be used for adding timber or metal strong backs to clay bricks or soft stone blocks, connecting plywood or wooden panels to clay bricks or soft stone blocks. Other uses may include attaching shear studs (or dowels) for concrete layer application, connecting steel elements to clay bricks or soft stone blocks and connecting timber elements to clay bricks or soft stone blocks.

Referring to FIGS. 9 to 19 the clay brick or soft stone block fastener 400, has a shank having a first 485 and second portions 480 and a tip 442.

The first portion 485 has a tapered helical screw 444 along the longitudinal length of the first portion 485. The tapered helical screw commencing at a tip of the first end thereof and ending at the second portion. The tapered helical screw type of the first portion is optimized for clay bricks or soft stone blocks.

The second portion 480 has a tapered helical screw along a longitudinal length thereof. The tapered helical screw of the second portion 480 commences at the end of the first portion 485 and end at the head 450. The tapered helical screw type of the first portion is optimized for timber.

Notches 445 may be formed on the crest of the helical thread along the length of the screw, more frequent end notches (saw teeth) may be formed in about the first three revolutions at the tip 442 in order to facilitate embedment of the crest into the masonry substrate.

The notches 445 may facilitate embedment of the crest of the helical threads into the masonry substrate of the clay bricks or soft stone blocks.

In other embodiments such as attaching metal to clay bricks or soft stone blocks the first and second portions may have a continuous thread type optimized for clay bricks or soft stone blocks.

The shank of the clay brick or soft stone block fastener 400 has ductility measured as the bending angle under complete three repeated cycles discussed above.

EN 14592 provides a ductility measure with the level of performance measured from S1 to S3. S3 being the highest level. The test requires a fitting being bent three times to a bending angle.

The degrees of bendability using this measure is expressed as:

$$a = \frac{45}{{d}^{0.7}}$$

α is expressed in degrees and d is the nominal diameter of the shank, in mm.

Ductility class S3 requires three repeated cycles at the bending angle before breaking of S3=2×α

In a typical embodiment

$$a = \frac{45}{{d}^{0.7}} = \frac{45}{{8}^{0.7}} = 10.5 and$$

$$S 3 = 2 \times α = 10.5 \times 2 = 21.$$

Thus, the clay brick or soft stone block fastener 400 would typically have a bending angle of about 21.0°. In a preferred embodiment the bending angle under complete three repeated cycles without rupture would be between about 10° and 22°.

The shank diameter of the clay brick or soft stone block fastener 400 is between about 6 mm and about 10 mm. Preferably the shank diameter is about 8 mm.

The tapered helical screw 444 portions 480, 485 of the clay brick or soft stone block fasteners 400 have a thread spacing of between about 5.5 mm and about 10 mm. Preferably the thread spacing is about 8 mm.

The thread 444 of first portion 485 of the clay brick or soft stone block fasteners 400 is designed to cut a spiral groove into the masonry substrate when inserted into a predrilled hole and turned. The spiral groove cuts without damaging the surrounding clay brick or soft stone block.

The thread 444 of second portion 480 of the clay brick or soft stone block fasteners 400 is designed to cut a spiral groove into timber or the like when inserted into a predrilled hole and turned.

The clay brick or soft stone block fasteners 400 is turned by a head 450 on the clay brick or soft stone block fasteners 400. The head 450 has in one embodiment a torx head 460, however other suitable head types including hex, square recess, pozi, p Phillips, slotted and hex head cap screw may be used.

The clay brick or soft stone block fasteners 400 shank length is between about 200 mm and about 400 mm, but the length may be adjusted to suit the use of the clay brick or soft stone block fasteners 400. Likewise the proportion of the shaft optimized for screwing into brick/block or wood may be altered depending on the use.

The clay brick fasteners 400 is preferably manufactured using tempered steel to provide ductile response. Other materials (manganese, carbon, silicon, aluminum, phosphorus) may be used that provide a good ductile response.

The clay brick fasteners 400 may be installed using the following installation procedure:
Mark the position for the masonry cavity screw on the face of the timber.
Drill a suitable diameter pilot hole through the timber and into the brick/block, to predetermined depth, using a rotary percussion drill. Using the preferred diameter fasteners 400 the hole would be 8 mm.
Insert the clay brick or soft stone block fasteners 400 into pre-drilled hole.
Manually or power-drive the clay brick or soft stone block fasteners 400 into position until its outer end is recessed below the face of timber.
Make good the entry hole with matching materials (if needed).

Uses of the clay brick or soft stone block fasteners 400 may include masonry parapet securing; masonry wall to additional member connections (such as steel or timber strong-backs); and use as tension and shear dowels.

Additional uses of the clay brick or soft stone block fasteners 400 may include connecting plywood or wooden panels to clay bricks or soft stone blocks and use as masonry wall interleaf ties in cases such as poor interleaf (wythe) interconnection and where danger of delamination of the wall cross-section exists.

While the present invention has been illustrated by the description of the embodiments thereof, and while the embodiments have been described in detail, it is not the intention of the Applicant to restrict or in any way limit the scope of the appended claims to such detail. Additional advantages and modifications will readily appear to those skilled in the art. Therefore, the invention in its broader aspects is not limited to the specific details, representative apparatus and method, and illustrative examples shown and described. Accordingly, departures may be made from such details without departure from the spirit or scope of the Applicant's general inventive concept.

1. A masonry cavity wall tie, comprising:
a shank having a first shank portion, a second shank portion, and a third shank portion, the shank having a tip at one end and a head at a second distal end, the shank having ductility measured as a bending angle under complete three repeated cycles without rupture of between about 12.5° and 26°;
the first shank portion commencing at the tip of the shank at a first shank portion first end and extending partially towards the head of the shank and ending at a first shank portion second end;
the second shank portion commencing at the first shank portion second end at a second shank portion first end and extending towards the head of the shank and ending at a second shank portion second end;
the third shank portion commencing at the second shank portion second end at a third shank portion first end and extending towards the head of the shank and ending at a third shank portion second end;
the first shank portion having a helical thread of a first diameter along a predetermined longitudinal length of the first shank portion; and
the second shank portion being unthreaded; and
the third shank portion having a helical thread of a second diameter along a predetermined longitudinal length of the second shank portion,
wherein the first and second diameters are the same, wherein the second shank portion is between about 25% and about 30% of the wall tie length and wherein the shank diameter is between about 5.5 mm and about 10 mm.

2. The masonry cavity wall tie of claim 1 wherein the second shank portion is about 28% of the wall tie length.

3. The masonry cavity wall tie of claim 1 wherein the second shank portion length is between about 60 mm and about 90 mm.

4. The masonry cavity wall tie of claim 1 wherein the shank diameter is about 6 mm.

5. The masonry cavity wall tie of claim 2 wherein the shank diameter is about 6 mm.

6. The masonry cavity wall tie of claim 3 wherein the shank diameter is about 6 mm.

7. The masonry cavity wall tie of claim 1 wherein the masonry wall tie is adapted for use with clay brick or soft stone masonry.

8. The masonry cavity wall tie of claim 1 wherein the clay bricks or stone blocks have up-to 35 MPa compression strength.

9. The masonry cavity wall tie of claim 1 wherein the bending angle is about 25.7°.

10. The masonry cavity wall tie of claim 1 wherein the helical thread of the first diameter and the helical thread of the second diameter have a thread spacing of between about 5.5 mm and about 10 mm.

11. The masonry cavity wall tie of claim 1 wherein the thread spacing is about 6 mm.
